(19) United States
(12) Patent Application Publication
(10) Pub. No.: US 2016/0028705 A1
(43) Pub. Date: Jan. 28, 2016

(54) COMMUNICATION SYSTEM AND ROUTER

(71) Applicant: FUJI XEROX CO., LTD., Tokyo (JP)

(72) Inventor: Kenji KAWANO, Kanagawa (JP)

(73) Assignee: FUJI XEROX CO., LTD., Tokyo (JP)

(21) Appl. No.: 14/614,499

(22) Filed: Feb. 5, 2015

(30) Foreign Application Priority Data
Jul. 25, 2014 (JP) 2014-151626

(51) Int. Cl. H04L 29/06; H04L 29/08

(52) U.S. Cl. CPC H04L 63/08; H04L 63/10; H04L 67/141

(57) ABSTRACT

A communication system includes an authentication apparatus, a router and a second apparatus. The authentication apparatus includes a first acquisition unit that acquires first authentication information of a user of a first apparatus, an authentication unit that performs authentication using the first authentication information, and a first transmission unit that transmits an address of a second apparatus to the first apparatus and transmits an address of the router to the second apparatus. The router includes a second transmission unit that acquires the address of the second apparatus and second authentication information of the user, and transmits the address of the router and the second authentication information. The second apparatus includes a second acquisition unit that acquires the address transmitted by the first transmission unit, a third acquisition unit that acquires the second authentication information and the address, and a connection unit that establishes connection to the router.

### CROSS-REFERENCE TO RELATED APPLICATIONS

This application is based on and claims priority under 35 USC 119 from Japanese Patent Application No. 2014-151626 filed Jul. 25, 2014.

### BACKGROUND

### Technical Field

The present invention relates to a communication system and a router.

### SUMMARY

According to an aspect of the invention, there is provided a communication system. The communication system includes an authentication apparatus, a router and a second apparatus. The authentication apparatus includes a first acquisition unit that acquires first authentication information of a user of a first apparatus, an authentication unit that performs authentication using the first authentication information acquired by the first acquisition unit, and a first transmission unit that, in response to authentication results of the authentication unit, transmits an address of a second apparatus to the first apparatus and transmits an address of the router connected to the first apparatus to the second apparatus. The router includes a second transmission unit that acquires the address of the second apparatus and second authentication information of the user from the first apparatus connected to the router, and transmits the address of the router together with the second authentication information to the second apparatus of the acquired address. The second apparatus includes a second acquisition unit that acquires the address transmitted by the first transmission unit, a third acquisition unit that acquires the second authentication information and the address transmitted by the second transmission unit, and a connection unit that establishes connection to the router if the address acquired by the second acquisition unit matches the address acquired by the third acquisition unit, and the second authentication information acquired by the third acquisition unit is stored on a memory.

### BRIEF DESCRIPTION OF THE DRAWINGS

Exemplary embodiments of the present invention will be described in detail based on the following figures, wherein:

FIG. 1 illustrates a communication system of a first exemplary embodiment of the present invention;

FIG. 2 is a block diagram illustrating the hardware configuration of a terminal apparatus;

FIG. 3 is a functional block diagram of the terminal apparatus;

FIG. 4 is a block diagram illustrating the hardware configuration of an authentication apparatus;

FIG. 5 illustrates an example of an authentication table;

FIG. 6 is a functional block diagram of the authentication apparatus;

FIG. 7 is a block diagram illustrating the hardware configuration of a server apparatus;

FIG. 8 illustrates an example of an authentication table;

FIG. 9 is a functional block diagram of the server apparatus;

FIG. 10 is a block diagram illustrating the hardware configuration of a router;

FIG. 11 is a functional block diagram of the router;

FIG. 12 illustrates the process of the first exemplary embodiment;

FIG. 13 illustrates an apparatus forming a communication system of a second exemplary embodiment of the present invention;

FIG. 14 is a functional block diagram of a terminal apparatus;

FIG. 15 illustrates an example of an authentication table;

FIG. 16 is a functional block diagram of an authentication apparatus;

FIG. 17A and FIG. 17B are functional block diagrams of a first router and a second router; and

FIG. 18 illustrates the process of the second exemplary embodiment.

### DETAILED DESCRIPTION

### First Exemplary Embodiment

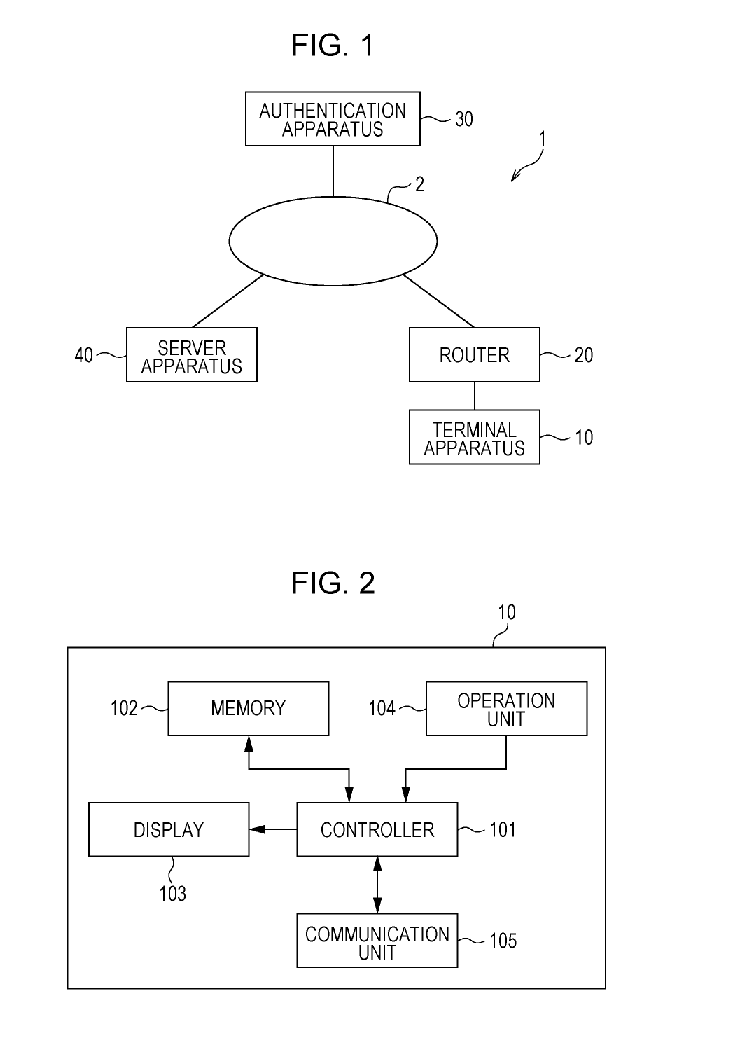

FIG. 1 illustrates a communication system 1 of a first exemplary embodiment of the present invention. A communication network 2 includes the Internet or a public telephone network. A terminal apparatus 10 is a computer and is connected to a router 20. The terminal apparatus 10 is an example of a first apparatus in the exemplary embodiment of the present invention. The terminal apparatus 10 communicates with a computer connected to the communication network 2 via the router 20. The terminal apparatus 10 of the first exemplary embodiment is not limited to a personal computer, and may be a computer, such as a tablet terminal, for use in data communications. The router 20 is connected to the terminal apparatus 10 and the communication network 2. The router 20 connects a computer network including the terminal apparatus 10 to the communication network 2, and relays communications to be performed by the terminal apparatus 10.

A server apparatus 40 provides a variety of services to the terminal apparatus 10. The server apparatus 40 is an example of a second apparatus in the exemplary embodiments of the present invention. The server apparatus 40 is connected to the communication network 2. An authentication apparatus 30 authenticates a user, and is connected to the communication network 2. The authentication apparatus 30 is an example of an authentication apparatus in the exemplary embodiments of the present invention. Using information transmitted from the terminal apparatus 10, the authentication apparatus 30 authenticates the user, and permits the terminal apparatus 10 to be connected to the server apparatus 40. The communication system 1 may include multiple terminal apparatuses 10, multiple routers 20, and multiple server apparatuses 40. To simplify the illustration, FIG. 1 only illustrates a single terminal apparatus 10, a single router 20, and a single server apparatus 40.

FIG. 2 is a block diagram illustrating the hardware configuration of the terminal apparatus 10. A display 103 in the terminal apparatus 10 is a display device. The display 103 displays a variety of types of screen to operate the terminal apparatus 10. An operation unit 104 includes input devices, such as a keyboard and a mouse, to operate the terminal apparatus 10. A communication unit 105 operates as a communication interface to perform data communications, and is connected to the router 20.

In the terminal apparatus 10, a memory 102 includes a device (such as a hard disk drive) to store data in a non-volatile fashion. The memory 102 stores an operating system (OS) program and an application program. In the first exemplary embodiment, the terminal apparatus 10 stores an application program to establish connection with the server apparatus 40 (hereinafter referred to as a connection application).

In the terminal apparatus 10, a controller 101 includes a central processing unit (CPU), and a random-access memory (RAM). The CPU executes the operation system program and the application programs. When the CPU executes the connection application, the function to establish connection with the server apparatus 40 is implemented.

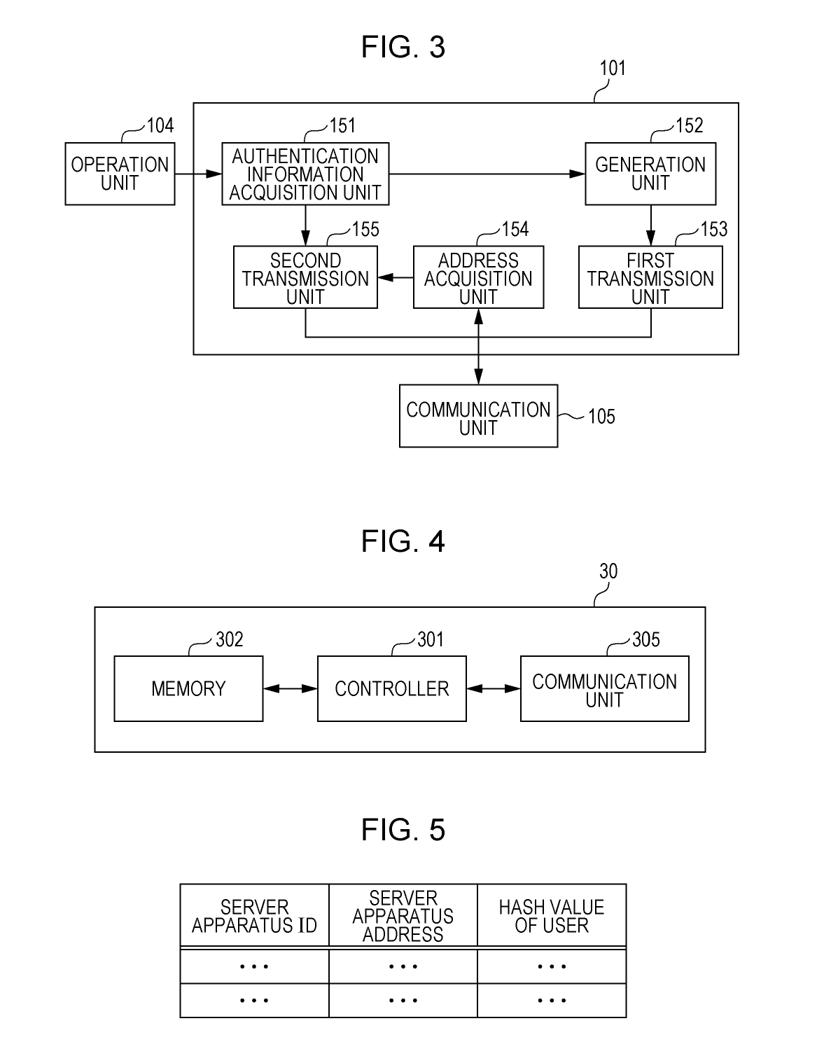

FIG. 3 is a functional block diagram of the function of the exemplary embodiments from among the functions implemented by executing the connection application.

In the functional block diagram, an authentication information acquisition unit 151 acquires a user name and a password that a user enters using an operation unit 104. A generation unit 152 generates a hash value as an example of first authentication information of the user based on the user name and password acquired by the authentication information acquisition unit 151. A first transmission unit 153 transmits the hash value generated by the generation unit 152 to the authentication apparatus 30 by controlling the communication unit 105. An address acquisition unit 154 acquires an Internet protocol (IP) address transmitted by the authentication apparatus 30 and received by the communication unit 105. A second transmission unit 155 transmits a connection request requesting connection to an apparatus identified by the IP address to the router 20 by controlling the communication unit 105. The connection request includes the IP address acquired by the address acquisition unit 154, and the user name and password acquired by the authentication information acquisition unit 151.

FIG. 4 is a block diagram illustrating the hardware configuration of the authentication apparatus 30. In the authentication apparatus 30, a communication unit 305 operates as a communication interface to perform data communications, and is connected to the communication network 2. A memory 302 includes a device that stores data (such as a hard disk drive) in a non-volatile fashion, and stores an authentication table TB1.

FIG. 5 illustrates an example of the authentication table TB1. The authentication table TB1 includes a “server apparatus identification (ID)” field, a “server apparatus address” field, and a “hash value of user” field. The “server apparatus ID” field stores an ID uniquely identifying the server apparatus 40. If multiple server apparatuses 40 are connected to the communication network 2, the ID of each server apparatus 40 is stored in the “server apparatus ID” field. The “server apparatus address” field stores an IP address assigned to the server apparatus 40 identified by the server apparatus ID at the same row of the authentication table TB1. The “hash value of user” field stores a hash value calculated from a combination of user name and password of a user who is permitted to be connected to the server apparatus 40.

A memory 302 stores a program that performs a function of communicating with another apparatus, and a function of authenticating a user of the terminal apparatus 10 and permitting the terminal apparatus 10 to be connected to the server apparatus 40 in response to authentication results. A controller 301 includes a CPU and a RAM, and controls the memory 302 and the communication unit 305. The CPU of the controller 301 executes the program stored on the memory 302, thereby performing the functions.

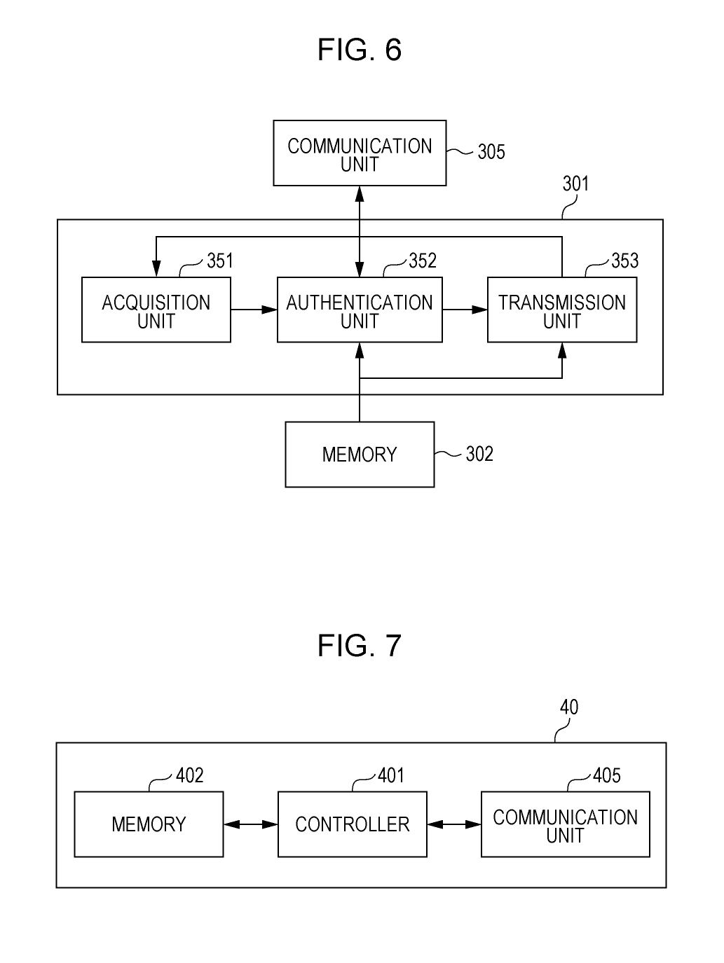

FIG. 6 is a functional block diagram of functions of the exemplary embodiments of the present invention from among the functions implemented by the authentication apparatus 30.

In the functional block diagram, an acquisition unit 351 acquires a hash value transmitted by the terminal apparatus 10 and received by the communication unit 305. The acquisition unit 351 is an example of a first acquisition unit that acquires the hash value as an example of first authentication information. An authentication unit 352 authenticates the user of the terminal apparatus 10 in accordance with the hash value acquired by the acquisition unit 351 and the hash value stored in the authentication table TB1. The authentication unit 352 is an example of an authentication unit that authenticates the user with the first authentication information acquired by the first acquisition unit. In response to authentication results of the authentication unit 352, a transmission unit 353 transmits an IP address of the server apparatus 40 via the communication unit 305 to the terminal apparatus 10, and transmits an IP address of the router 20 connected to the terminal apparatus 10 to the server apparatus 40 via the communication unit 305. The transmission unit 353 is an example of a first transmission unit that transmits the IP address of the server apparatus 40 as an example of a second apparatus to the terminal apparatus 10 as an example of a first apparatus, and transmits the address of the router connected to the terminal apparatus 10 to the server apparatus 40.

FIG. 7 is a block diagram illustrating the hardware configuration of the server apparatus 40. A communication unit 405 operates as a communication interface for data communications, and is connected to the communication network 2. A memory 402 includes a device that stores data (such as a hard disk device) in a non-volatile fashion, and stores data received from the terminal apparatus 10 and data to be transmitted to the terminal apparatus 10.

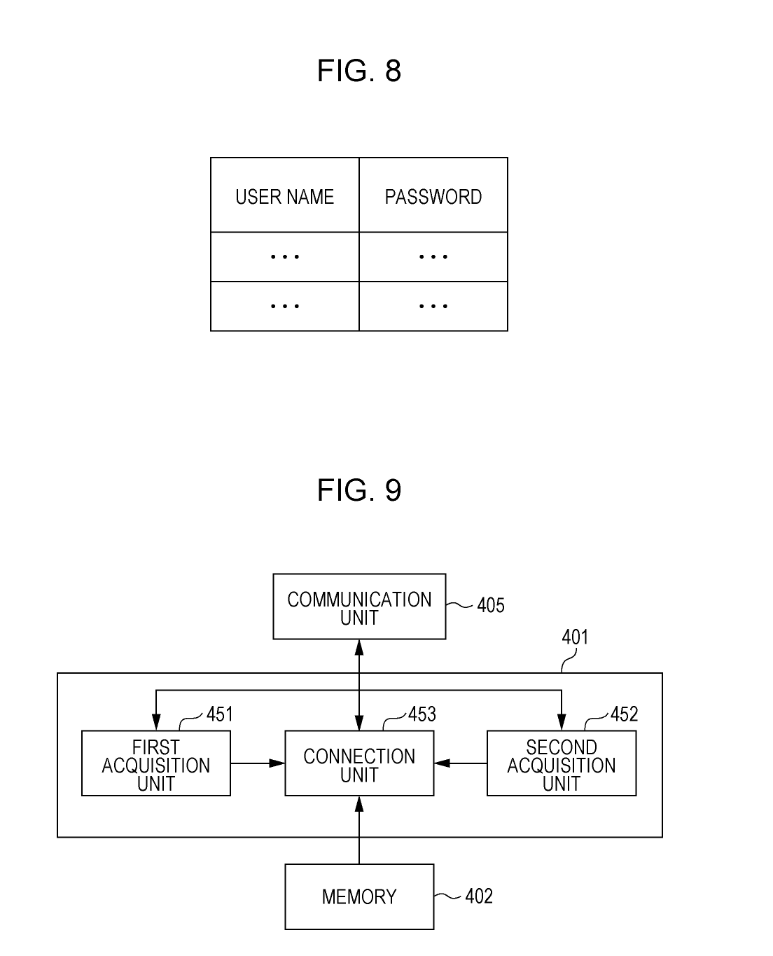

The memory 402 stores an authentication table TB2. FIG. 8 illustrates an example of the authentication table TB2. The authentication table TB2 includes a “user name” field, and a “password” field. The “user name” field stores the user name of a user who is permitted to be connected to the server apparatus 40. If multiple users are permitted, the user name of each user is stored. The “password” field stores the password of the user who is permitted to be connected to the server apparatus 40.

The memory 402 stores a program that implements a function of communicating with another apparatus and a function of establishing connection with the terminal apparatus 10. A controller 401 includes a CPU and a RAM, and controls the memory 402 and the communication unit 405. When the CPU executes the program stored on the memory 402, the functions are performed.

FIG. 9 is a functional block diagram of the functions of the exemplary embodiments of the present invention from among the functions implemented by the server apparatus 40.

A first acquisition unit 451 in the controller 401 acquires an IP address of the router 20 transmitted by the authentication apparatus 30 and received by the communication unit 405. The first acquisition unit 451 is an example of a second acquisition unit that acquires the IP address of the authentication apparatus 30. A second acquisition unit 452 acquires the IP address, the user name, and the password, transmitted by the router 20 and received by the communication unit 405. The second acquisition unit 452 is an example of a third acquisition unit that acquires the user name and password, as an example of first authentication information of the user transmitted by the router 20. A connection unit 453 is an example of a connection unit that controls the communication unit 405 to establish connection with an apparatus of the IP address if the IP address acquired by the first acquisition unit 451 matches the IP address acquired by the second acquisition unit 452, and the user name and password acquired by the second acquisition unit 452 are stored on the memory 402.

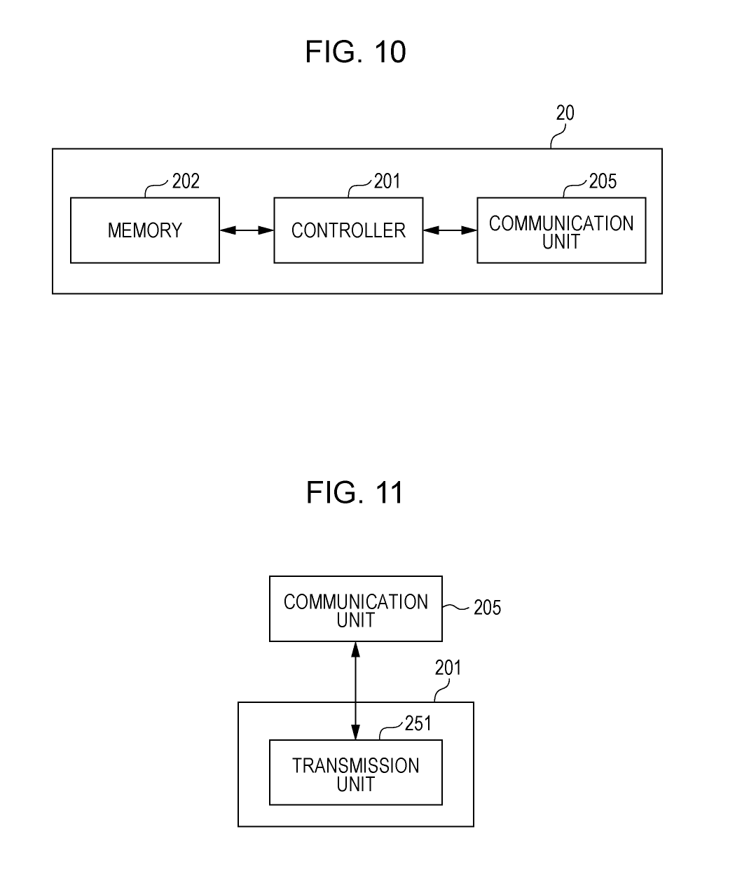

FIG. 10 is a block diagram illustrating the hardware configuration of the router 20. A communication unit 205 is connected between the communication network 2 and the terminal apparatus 10, and relays communications between the terminal apparatus 10 and the communication network 2. A memory 202 stores data in a non-volatile fashion. The memory 202 stores a program that implements a function of relaying communications and a function of establishing a virtual private network (VPN) with the server apparatus 40. A controller 201 includes a CPU and a RAM, and controls the memory 202 and the communication unit 205. When the CPU of the controller 201 executes the program stored on the memory 202, the functions are performed.

FIG. 11 is a block diagram illustrating functions of the exemplary embodiments of the present invention from among the functions of the router 20.

A transmission unit 251 is an example of a second transmission unit that acquires the IP address, the user name, and password transmitted by the terminal apparatus 10 and received by the communication unit 205, and transmits to an apparatus of the acquired IP address the IP address of the router 20 on a wide area network (WAN), and the acquired user name and password.

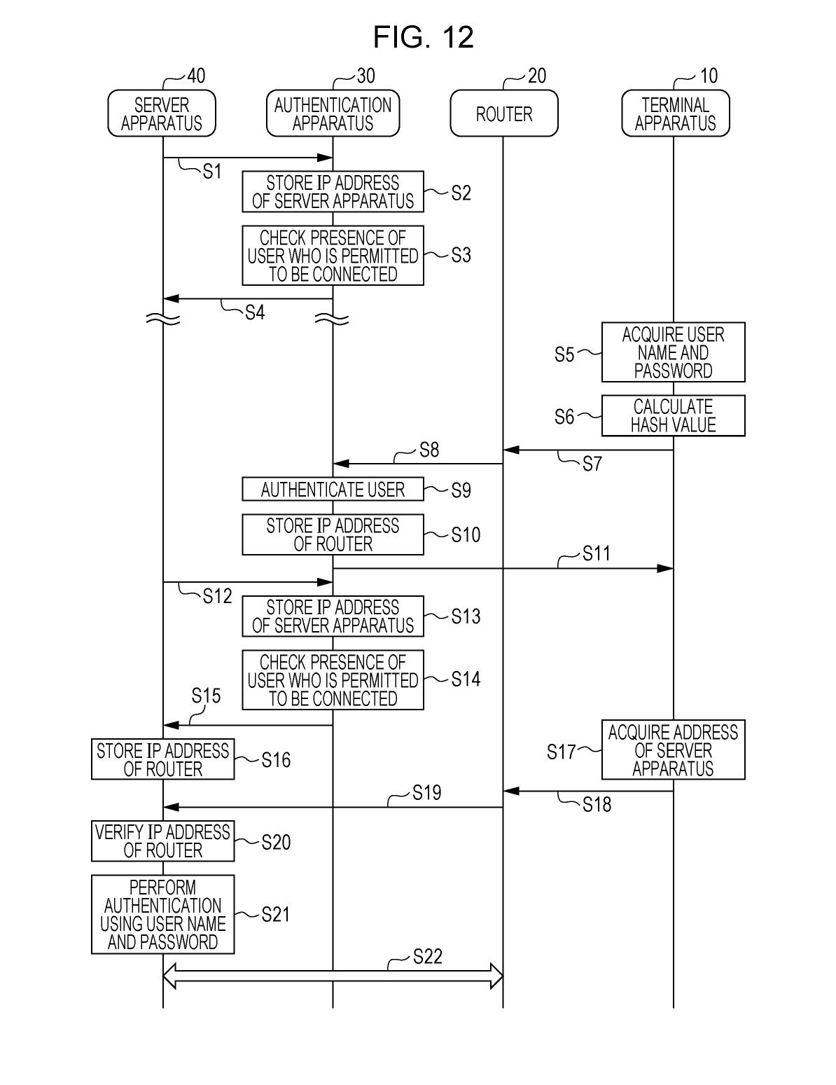

An operation example to connect the terminal apparatus 10 to the server apparatus 40 in the first exemplary embodiment is described with reference to FIG. 12.

The controller 401 transmits a first message to the authentication apparatus 30 by controlling the communication unit 405 (step S1). The first message inquires of the presence or absence of a user who is permitted to be connected to the server apparatus 40, and includes the server apparatus ID and IP address of the server apparatus 40. When the communication unit 305 receives the first message transmitted in step S1, the controller 301 stores the IP address included in the received first message in the authentication table TB1 (step S2). More specifically, the controller 301 searches the authentication table TB1 for the server apparatus ID included in the first message received. If the server apparatus ID included in the first message is hit, the controller 301 stores the IP address included in the first message in the “server apparatus address” field at the row that stores the hit server apparatus ID.

The controller 301 checks the presence or absence of the user who is permitted to be connected to the server apparatus 40 that has transmitted the first message (step S3). More specifically, the controller 301 determines whether the IP address of the router 20 connected to the terminal apparatus 10 is stored on the memory 302. If the IP address of the router 20 connected to the terminal apparatus 10 is not stored on the memory 302, the controller 301 determines that there is no user at this moment who is permitted to be connected to the server apparatus 40. The controller 301 transmits a second message to the server apparatus 40 by controlling the communication unit 305 (step S4). The second message notifies the server apparatus 40 that no user is permitted to be connected to the server apparatus 40.

When the communication unit 405 receives the second message transmitted in step S4, the controller 401 waits on standby until a predetermined period of time has elapsed. When the predetermined period of time has elapsed, the controller 401 transmits the first message again. The first message and second message are periodically exchanged between the server apparatus 40 and the authentication apparatus 30 until a user who is permitted to be connected to the server apparatus 40 is recognized.

In order to connect the terminal apparatus 10 to a remote access destination (the server apparatus 40 in the first exemplary embodiment), the user of the terminal apparatus 10 operates the operation unit 104 to instruct the connection application to be performed. In response to the instruction of the connection application, the controller 101 executes the connection application stored on the memory 102.

The controller 101 having executed the connection application controls the display 103 to display a screen that receives the user name and password. When the screen that receives the user name and password is displayed, the user enters the user name and password using the operation unit 104. When the user name and password are entered, the controller 101 acquires the input user name and password (step S5), and calculates a hash value from the combination of the acquired user name and password (step S6). After completing the calculation of the hash value, the controller 101 transmits a first request to the authentication apparatus 30 by controlling the communication unit 105 (step S7). The first request includes the calculated hash value and requests permission to connect to the remote access connection destination.

The first request transmitted by the terminal apparatus 10 is transmitted to the router 20 first. The router 20 includes in the first request an IP address of the router 20 on the communication network 2 (WAN), and transmits the resulting first request to the authentication apparatus 30 (step S8). The first request transmitted from the router 20 is transmitted to the authentication apparatus 30 via the communication network 2.

When the communication unit 305 receives the first request, the controller 301 authenticates the user of the terminal apparatus 10 (step S9). More specifically, the controller 301 (the acquisition unit 351) acquires the hash value included in the first request. The controller 301 (the authentication unit 352) searches the authentication table TB1 for the acquired hash value. If the hash value included in the first request is not stored in the authentication table TB1, the controller 301 denies the request to permit connection to the server apparatus 40. On the other hand, if the hash value included in the first request is stored in the authentication table TB1, the controller 301 permits the user to connect to the server apparatus 40. Upon permitting the user to connect to the server apparatus 40, the controller 301 causes the IP address of the router 20 included in the received first request to be stored on the memory 302 (step S10).

The controller 301 (the transmission unit 353) acquires a server apparatus address stored at the same row as the hash value included in the first request in the authentication table TB1, and transmits a first response by controlling the communication unit 305 (step S11). The first response is responsive to the first request and includes the acquired server apparatus address.

When a predetermined period of time has elapsed since the transmission of the first message, the server apparatus 40 transmits the first message again (step S12). When the communication unit 305 receives the first message transmitted in step S12, the controller 301 stores the IP address included in the received first message in the authentication table TB1 in the same way as in step S2 (step S13).

The controller 301 checks the presence or absence of a user who is permitted to be connected to the server apparatus 40 (step S14). Since the IP address of the router 20 connected to the terminal apparatus 10 is stored on the memory 302 in step S10, the controller 301 determines that the user permitted to be connected to the server apparatus 40 is present. Upon determining that the user permitted to be connected to the server apparatus 40 is present, the controller 301 (the transmission unit 353) transmits a third message to the server apparatus 40 (step S15). The third message includes the IP address of the router 20 stored on the memory 302 in step S10 and is used to notify the server apparatus 40 that the user permitted to be connected to the server apparatus 40 is present. When the communication unit 405 receives the third message transmitted in step S15, the controller 401 (the first acquisition unit 451) acquires the IP address of the router 20 included in the third message and causes the acquired IP address to be stored on the memory 402 (step S16).

The first response transmitted by the authentication apparatus 30 in step S11 is transmitted to the router 20 via the communication network 2. The router 20 transmits the first response to the terminal apparatus 10. When the communication unit 105 receives the first response, the controller 101 acquires the IP address (the server apparatus address) included in the first response (step S17). The controller 101 transmits a second request to the router 20 (step S18). The second request includes the server apparatus address acquired from the first response, and the user name and password entered by the user, and instructs the router 20 to connect to the server apparatus 40 identified by the acquired address (the server apparatus address).

When the communication unit 205 receives the second request, the controller 201 (the transmission unit 251) transmits a third request to the server apparatus 40 (step S19). The third request includes the IP address of the router 20 on the WAN side, the user name included in the second request, and the password included the second request, and requests a VPN connection to be established.

When the communication unit 405 receives the third request, the controller 401 (the second acquisition unit 452 and the connection unit 453) acquires the IP address included in the third request, and verifies whether the acquired address is stored on the memory 402 (step S20). If the IP address included in the third request is not stored on the memory 402, the controller 401 (the connection unit 453) denies the third request. On the other hand, if the IP address included in the third request is stored on the memory 402, the controller 401 (the connection unit 453) authenticates the user using the user name and password (step S21). More specifically, the controller 401 searches the authentication table TB2 for the combination of the user name and password included in the third request. If the combination of the user name and password is hit, the controller 401 accepts the request to establish the VPN connection. Upon accepting the request to establish the VPN connection, the controller 401 communicates with the router 20 and then establishes a VPN between the server apparatus 40 and the router 20 (step S22). If the VPN is established between the router 20 and the server apparatus 40, the terminal apparatus 10 communicates with the server apparatus 40 via the VPN.

In accordance with the first exemplary embodiment, the user of the terminal apparatus 10 simply enters the user name and password, and the terminal apparatus 10 gains remote access to the server apparatus 40 via the router 20.

### Second Exemplary Embodiment

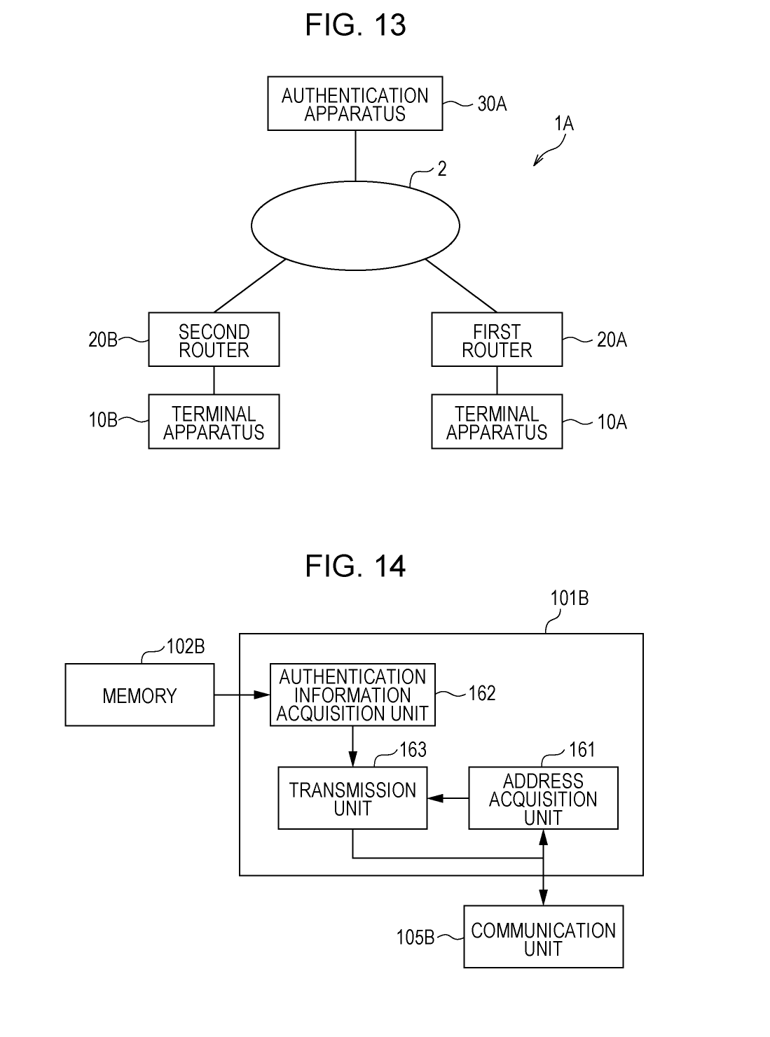

A second exemplary embodiment of the present invention is described below. FIG. 13 illustrates apparatuses forming a communication system 1A of the second exemplary embodiment of the present invention. A communication network 2 includes the Internet or a public telephone network. A terminal apparatus 10A is a computer and is connected to a first router 20A. The terminal apparatus 10A is an example of a first apparatus. A terminal apparatus 10B is a computer and is connected to a second router 20B. The terminal apparatus 10B is an example of a second apparatus. The terminal apparatus 10A communicates with a computer connected to the communication network 2 via the first router 20A. The terminal apparatus 10B communicates with a computer connected to the communication network 2 via the router 20B. The terminal apparatus 10A and the terminal apparatus 10B, identical in hardware configuration to the terminal apparatus 10 of the first exemplary embodiment, are configured as illustrated in FIG. 2. For convenience of explanation, each of the elements in the terminal apparatus 10A and the terminal apparatus 10B is suffixed by the letter “A” or “B” to discriminate an element in the terminal apparatus 10A from a corresponding element in the terminal apparatus 10B.

The terminal apparatus 10A stores a connection application on the memory 102A. When the controller 101A executes the connection application, the function similar to the function of the terminal apparatus 10 is performed. The application program stored on the memory 102B is different from that on the terminal apparatus 10. The terminal apparatus 10B is thus different from the terminal apparatus 10 in the function that is implemented by performing the application program. The terminal apparatus 10B stores the user name and password of a user who is permitted to be connected to the terminal apparatus 10B.

FIG. 14 is a functional block diagram of the terminal apparatus 10B. An address acquisition unit 161 acquires an Internet protocol (IP) address of the first router 20A transmitted by the authentication apparatus 30A and received by the communication unit 105B. The address acquisition unit 161 is an example of a second acquisition unit that acquires the address of the first router 20A. An authentication information acquisition unit 162 acquires a user name and password as an example of second authentication information stored on the memory 102B. A transmission unit 163 transmits to the second router 20B the user name and password acquired by the authentication information acquisition unit 162, and the address of the first router 20A acquired by the address acquisition unit 161. The transmission unit 163 is an example of a third transmission unit that transmits to the router 20B as an example of a second router the user name and password as the example of the second authentication information and the IP address of the first router 20A.

The authentication apparatus 30A authenticates the user of the terminal apparatus 10A, and is connected to the communication network 2. The authentication apparatus 30A is an example of an authentication apparatus in the second exemplary embodiment. The authentication apparatus 30A authenticates the user of the terminal apparatus 10A using information transmitted from the terminal apparatus 10A, and permits the terminal apparatus 10A to be connected to the terminal apparatus 10B in accordance with authentication results. The authentication apparatus 30A is identical in terms of hardware configuration and functional block to the authentication apparatus 30 of the first exemplary embodiment. In the following discussion, the hardware configuration and the functional blocks of the authentication apparatus 30A are described using the same reference numerals as those of the authentication apparatus 30.

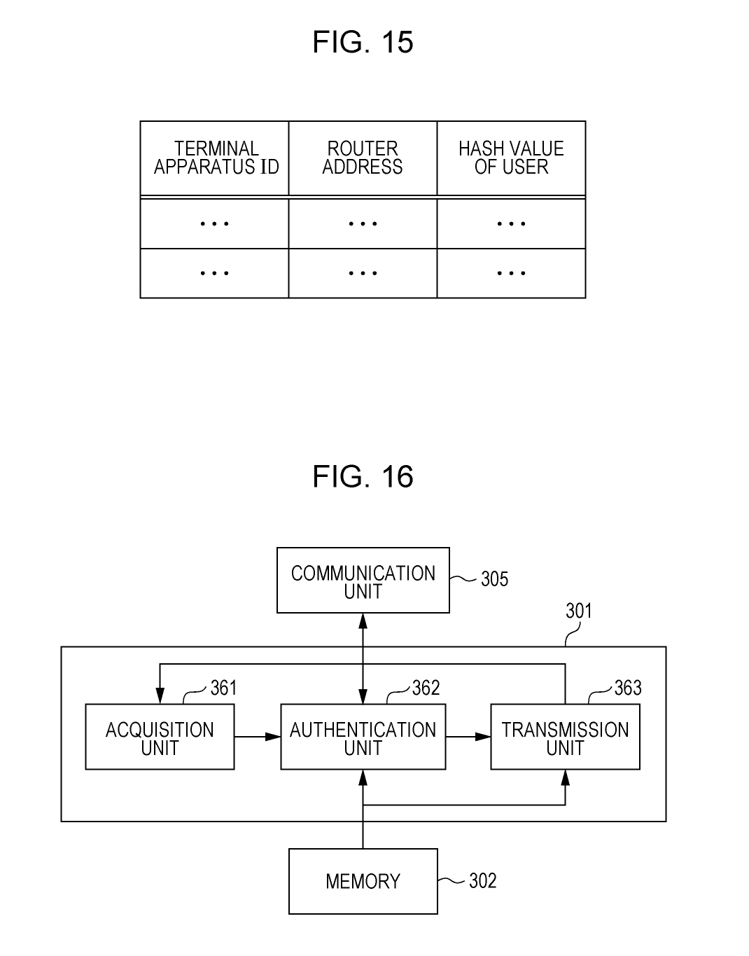

The authentication apparatus 30A stores an authentication table TB1A different from the authentication table TB1 in the first exemplary embodiment. FIG. 15 illustrates an example of the authentication table TB1A. The authentication table TB1A includes a “terminal apparatus ID” field, a “router address” field, and a “hash value of user” field. The “terminal apparatus ID” field stores an ID uniquely identifying the terminal apparatus 10B. The “router address” field stores the IP address of the second router 20B (the address on the WAN side) connected to the terminal apparatus 10B identified by the terminal apparatus ID at the same row. The “hash value of user” field stores a hash value calculated from a combination of user name and password of a user who is permitted to be connected to the terminal apparatus 10B.

FIG. 16 is a functional block diagram of the function implemented by the controller 301 of the second exemplary embodiment.

An acquisition unit 361 acquires a hash value transmitted by the terminal apparatus 10A and received by the communication unit 305A. The acquisition unit 361 is an example of a first acquisition unit that acquires the hash value as an example of first authentication information. An authentication unit 362 authenticates the user of the terminal apparatus 10A in accordance with the hash value acquired by the acquisition unit 361 and the hash value stored in the authentication table TB1A. The authentication unit 362 is an example of an authentication unit that authenticates the user with the first authentication information acquired by the first acquisition unit. In response to authentication results of the authentication unit 362, a transmission unit 363 transmits an IP address of the second router 20B to the terminal apparatus 10A by controlling the communication unit 305, and transmits an IP address of the first router 20A connected to the terminal apparatus 10A to the terminal apparatus 10B by controlling the communication unit 305. The transmission unit 363 is an example of a first transmission unit that transmits the IP address of the second router 20B to the terminal apparatus 10A as an example of a first apparatus, and transmits the address of the first router 20A connected to the terminal apparatus 10A to the terminal apparatus 10B as an example of a second apparatus.

The first router 20A is connected the terminal apparatus 10A and the communication network 2, and the second router 20B is connected to the terminal apparatus 10B and the communication network 2. The first router 20A is an example of the first router in the second exemplary embodiment, and the second router 20B is an example of the second router of the second exemplary embodiment. The first router 20A connects a computer network of the terminal apparatus 10A to the communication network 2, and relays communications performed by the terminal apparatus 10A. The second router 20B connects a computer network of the terminal apparatus 10B to the communication network 2, and relays communications performed by the terminal apparatus 10B. The first router 20A and the second router 20B, identical in hardware configuration to the router 20 of the first exemplary embodiment, is configured as illustrated in FIG. 10. For convenience of explanation, each of the elements in the first router 20A and the second router 20B is suffixed by the letter “A” or “B” to discriminate an element in the first router 20A from a corresponding element in the second router 20B.

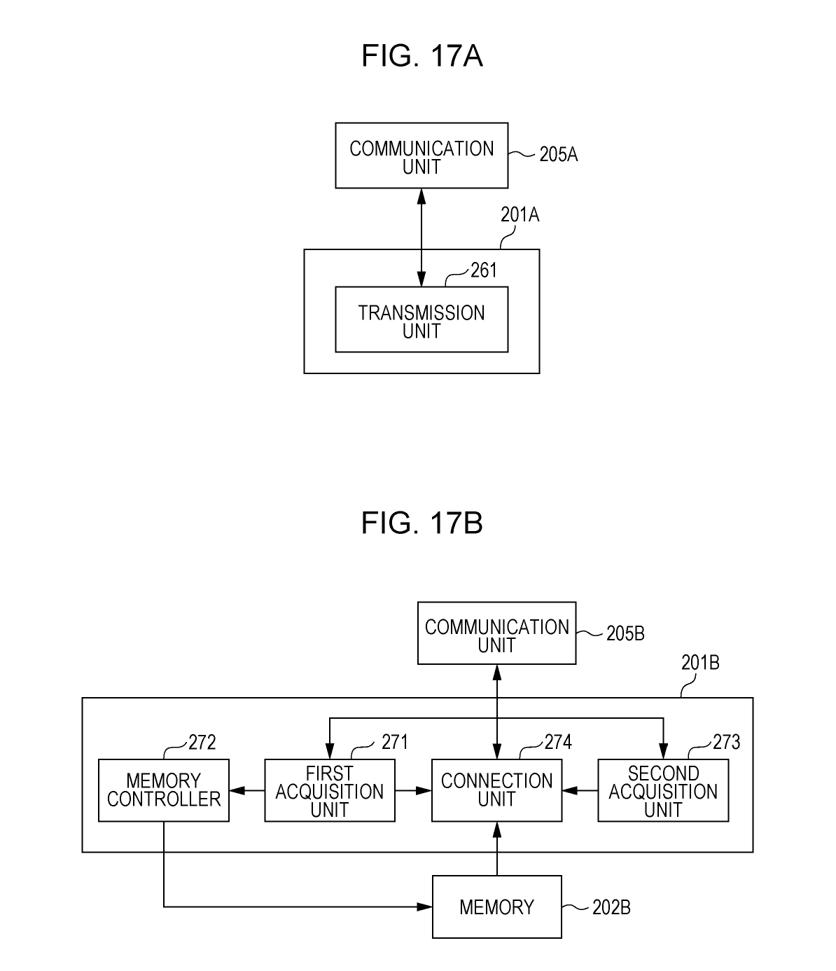

FIG. 17A is a block diagram illustrating functions of the second exemplary embodiment from among the functions of the first router 20A. A transmission unit 261 acquires the IP address, the user name, and password transmitted by the terminal apparatus 10A and received by the communication unit 205A, and transmits to an apparatus of the acquired IP address the IP address of the first router 20A on a wide-area network, and the acquired user name and password. The transmission unit 261 is an example of a second transmission unit. The second transmission unit acquires from the terminal apparatus 10A as an example of the first apparatus the IP address of the second router 20B and the user name and password as an example of second authentication information of the user of the terminal apparatus 10A, and transmits to the second router 20B the IP address of the first router 20A on the WAN side and the acquired second authentication information.

FIG. 17B is a functional block diagram of the functions of the second exemplary embodiment from among the functions implemented by the second router 20B.

A first acquisition unit 271 acquires the IP address of the first router 20A transmitted by the terminal apparatus 10B as an example of the second apparatus and the user name and password as an example of the second authentication information of the user of the terminal apparatus 10A. The first acquisition unit 271 is an example of a third acquisition unit of the second exemplary embodiment. A memory controller 272 is an example of a memory controller that acquires the IP address of the first router 20A, the user name, and the password, acquired by the first acquisition unit 271 onto a memory 202B. A second acquisition unit 273 acquires the IP address of the first router 20A, and the user name and password transmitted by the first router 20A. The second acquisition unit 273 is an example of a fourth acquisition unit. A connection unit 274 connects to the first router 20A if the IP address, and the user name and password acquired by the second acquisition unit 273 are stored on the memory 202B. The connection unit 274 is an example of the connection unit.

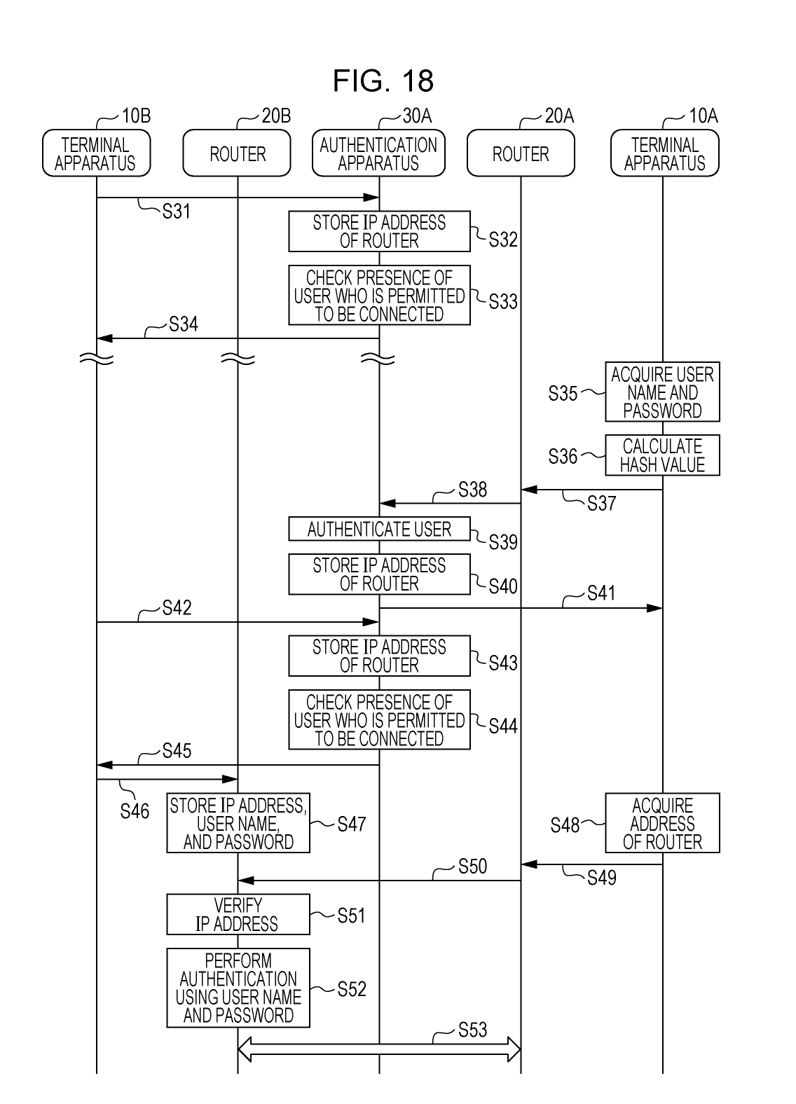

An operation example to connect the terminal apparatus 10A to the terminal apparatus 10B in the second exemplary embodiment is described with reference to FIG. 18.

The controller 101B transmits a fourth message to the authentication apparatus 30A by controlling the communication unit 105 (step S31). The fourth message inquires of the presence or absence of a user who is permitted to be connected to the terminal apparatus 10B, and includes the terminal apparatus ID of the terminal apparatus 10B and the IP address of the second router 20B on the WAN side. When the communication unit 305 receives the fourth message transmitted in step S31, the controller 301 stores the IP address included in the received fourth message in the authentication table TB1A (step S32). More specifically, the controller 301 searches the authentication table TB1A for the terminal apparatus ID included in the fourth message received. If the terminal apparatus ID included in the fourth message is hit, the controller 301 stores the IP address included in the fourth message in the “router address” field at the row that stores the hit terminal apparatus ID.

The controller 301 checks the presence or absence of the user who is permitted to be connected to the terminal apparatus 10B that has transmitted the fourth message (step S33). More specifically, the controller 301 determines whether the IP address of the first router 20A connected to the terminal apparatus 10A is stored on the memory 302. If the IP address of the first router 20A connected to the terminal apparatus 10A is not stored on the memory 302, the controller 301 determines that there is no user at this moment who is permitted to be connected to the terminal apparatus 10B. The controller 301 transmits a fifth message to the terminal apparatus 10B by controlling the communication unit 305 (step S34). The fifth message notifies the terminal apparatus 10B that no user is permitted to be connected to the terminal apparatus 10B.

When the communication unit 105B receives the fifth message transmitted in step S34, the controller 101B waits on standby until a predetermined period of time has elapsed. When the predetermined period of time has elapsed, the controller 101B transmits the fourth message again. The fourth message and fifth message are periodically exchanged between the terminal apparatus 10B and the authentication apparatus 30A until a user who is permitted to be connected to the terminal apparatus 10B is recognized.

The user of the terminal apparatus 10A operates the operation unit 104A to instruct the connection application to be performed to make remote access to a connection destination (the terminal apparatus 10B in the second exemplary embodiment). In response to the instruction of the connection application, the controller 101A executes the connection application stored on the memory 102A.

The controller 101A having executed the connection application controls the display 103A to display a screen that receives the user name and password. When the screen that receives the user name and password is displayed, the user enters the user name and password using the operation unit 104A. When the user name and password are entered, the controller 101A acquires the input user name and password (step S35), and calculates a hash value from the combination of the acquired user name and password (step S36). After completing the calculation of the hash value, the controller 101A transmits a fourth request to the authentication apparatus 30A by controlling the communication unit 105A (step S37). The fourth request includes the calculated hash value and requests permission to make remote access to the connection destination.

The fourth request transmitted by the terminal apparatus 10A is transmitted to the first router 20A first. The first router 20A includes in the fourth request an IP address of the first router 20A on the communication network 2 (WAN), and transmits the resulting fourth request to the authentication apparatus 30A (step S38). The fourth request transmitted from the first router 20A is transmitted to the authentication apparatus 30A via the communication network 2.

When the communication unit 305 receives the fourth request, the controller 301 authenticates the user of the terminal apparatus 10A (step S39). More specifically, the controller 301 (the acquisition unit 361) acquires the hash value included in the fourth request. The controller 301 (the authentication unit 362) searches the authentication table TB1A for the acquired hash value. If the hash value included in the fourth request is not stored in the authentication table TB1A, the controller 301 (the authentication unit 362) denies the request to permit connection to the terminal apparatus 10B. On the other hand, if the hash value included in the fourth request is stored in the authentication table TB1A, the controller 301 permits the user to connect to the terminal apparatus 10B. Upon permitting the user to connect to the terminal apparatus 10B, the controller 301 causes the IP address of the first router 20A included in the received fourth request to be stored on the memory 302 (step S40).

The controller 301 (the transmission unit 363) acquires the router address stored at the same row as the hash value included in the fourth request in the authentication table TB1A (the IP address of the second router 20B), and transmits a second response by controlling the communication unit 305 (step S41). The second response is responsive to the fourth request and includes the acquired router address.

When a predetermined period of time has elapsed since the transmission of the fourth message, the terminal apparatus 10B transmits the fourth message again (step S42). When the communication unit 305 receives the fourth message transmitted in step S42, the controller 301 stores the IP address included in the received fourth message in the authentication table TB1 in the same way as in step S32 (step S43).

The controller 301 checks the presence or absence of a user who is permitted to be connected to the terminal apparatus 10B (step S44). Since the IP address of the first router 20A connected to the terminal apparatus 10A is stored on the memory 302 in step S40, the controller 301 determines that the user permitted to be connected to the terminal apparatus 10B is present. Upon determining that the user permitted to be connected to the terminal apparatus 10B is present, the controller 301 (the transmission unit 363) transmits a sixth message to the terminal apparatus 10B (step S45). The sixth message includes the IP address of the first router 20A stored on the memory 302 in step S40 and is used to notify the terminal apparatus 10B that the user permitted to be connected to the terminal apparatus 10B is present. When the communication unit 105B receives the sixth message transmitted in step S45, the controller 101B (the address acquisition unit 161) acquires the IP address of the first router 20A included in the sixth message. The controller 101B (the authentication information acquisition unit 162 and the transmission unit 163) acquires from the memory 102B the user name and password of the user permitted to be connected to the terminal apparatus 10B, and transmits a seventh message to the second router 20B (step S46). The seventh message includes the IP address, and the user name and password acquired from the sixth message, and instructs a VPN connection to be established.

When the communication unit 205B receives the seventh message, the controller 201B (the first acquisition unit 271) acquires the IP address, and the user name and password included in the seventh message. The controller 201B (the memory controller 272) causes the memory 202B to store the acquired IP address (the IP address of the first router 20A), and the user name and password (step S47).

The second response transmitted by the authentication apparatus 30A is transmitted to the first router 20A via the communication network 2. The first router 20A transmits the second response to the terminal apparatus 10A. When the communication unit 105A receives the second response, the controller 101A acquires the IP address (the server apparatus address) included in the second response (the IP address of the second router 20B) (step S48). The controller 101A transmits a fifth request to the first router 20A (step S49). The fifth request includes the user name and password entered by the user, and instructs the first router 20A to connect to the second router 20B identified by the acquired IP address.

When the communication unit 205B receives the fifth request, the controller 201A (the transmission unit 261) transmits a sixth request to the second router 20B (step S50). The sixth request includes the IP address of the first router 20A on the WAN side, the user name included in the fifth request, and the password included the fifth request, and requests a VPN connection to be established.

When the communication unit 205B receives the sixth request, the controller 201B (the second acquisition unit 273) acquires the IP address, and the user name and password included in the sixth request. The controller 201B (the connection unit 274) verifies whether the IP address included in the sixth request is the IP address stored in step S47 (step S51). If the IP address included in the sixth request is not the IP address stored in step S47, the controller 201B (the connection unit 274) denies the sixth request. On the other hand, if the IP address included in the sixth request is the IP address stored in step S47, the controller 201B (the connection unit 274) authenticates the user in accordance with the user name and password (step S52). More specifically, the controller 201B (the connection unit 274) searches the memory 202B for the combination of the user name and password included in the sixth request. If the combination of the user name and password is hit, the controller 201B (the connection unit 274) accepts the request to establish the VPN connection. Upon accepting the request to establish the VPN connection, the controller 201B communicates with the first router 20A, and establishes the VPN between the second router 20B and the first router 20A (step S53). If the VPN is established between the first router 20A and the second router 20B, the terminal apparatus 10A communicates with the terminal apparatus 10B via the VPN.

In accordance with the second exemplary embodiment, the user of the terminal apparatus 10A simply enters the user name and password, and the terminal apparatus 10A gains remote access to the terminal apparatus 10B via the router 20A.

### Modifications

The exemplary embodiments of the present invention have been discussed. The present invention is not limited to the exemplary embodiments described above, and a variety of modifications is possible to the exemplary embodiments. The exemplary embodiments may be modified as described below. The exemplary embodiments and the modifications described below may be combined.

In the exemplary embodiments, the user name and password of the user who is permitted to be connected to the remote access destination are stored on the terminal apparatus 10 (the terminal apparatus 10A) performing remote accessing. If the combination of the user name and password input on the terminal apparatus 10 (the terminal apparatus 10A) is not stored, the connection process to the remote access destination may be stopped.

In the exemplary embodiments, the user is authenticated by transmitting the hash value from the terminal apparatus 10 (the terminal apparatus 10A) to the authentication apparatus 30 (the authentication apparatus 30A). The present invention is not limited to this configuration.

For example, the user name and password of the user who is permitted to connect to the server apparatus 40 (the terminal apparatus 10B) may be pre-stored on the authentication apparatus 30 (the authentication apparatus 30A). The terminal apparatus 10 (the terminal apparatus 10A) may transmit the user name and password instead of the hash value to the authentication apparatus 30 (the authentication apparatus 30A). The authentication apparatus 30 (the authentication apparatus 30A) may decode the user name and password, and may authenticate the user using the decoded user name and password.

In the first exemplary embodiment, the server apparatus 40 authenticates the user using the user name and password in response the reception of the third request from the router 20. The present invention is not limited to this configuration. For example, the authentication apparatus 30 may generate a one-time password upon authenticating the user, include the one-time password in the first response, and transmit to the terminal apparatus 10 the first response including the one-time password. The authentication apparatus 30 may include the one-time password in the third message, and transmit the third message to the server apparatus 40. When transmitting the second request, the terminal apparatus 10 may include in the second request the one-time password of the first response transmitted from the authentication apparatus 30 instead of the user name and password. In response to the reception of the second request, the server apparatus 40 accepts the request to establish the VPN connection if the one-time password included in the second request matches the one-time password included in the received third message. The server apparatus 40 thus establishes the VPN with the router 20.

In the second exemplary embodiment, the second router 20B authenticates the user in accordance with the user name and password upon receiving the sixth request from the router 20. The second exemplary embodiment may be modified in the configuration. For example, the authentication apparatus 30A may generate a one-time password when the user is authenticated, and may include the generated one-time password in the second response, and transmit the second response to the terminal apparatus 10A. The authentication apparatus 30A may include the generated one-time password in the sixth message and transmit the sixth message to the terminal apparatus 10B. When transmitting the seventh message, the terminal apparatus 10B may include in the seventh message the one-time password of the received sixth message instead of the user name and password. The second router 20B stores the one-time password in the seventh message. When transmitting the fifth request, the terminal apparatus 10A includes in the fifth request the one-time password of the second response transmitted from the authentication apparatus 30A instead of the user name and password. In response to the reception of the fifth request, the second router 20B accepts the request to establish the VPN connection if the one-time password included in the fifth request matches the one-time password included in the received seventh message. The second router 20B thus establishes the VPN with the second router 20B.

In the first exemplary embodiment, the server apparatus 40 may deny the third request if a predetermined period of time has elapsed since the reception of the third message. In the second exemplary embodiment, the second router 20B may deny the sixth request if a predetermined period of time has elapsed since the reception of the seventh message.

In the first exemplary embodiment, the server apparatus 40 may include in the first message the hash value generated from the combination of the user name and password stored in the authentication table TB2, and then transmit the first message. The authentication apparatus 30 may store the hash value included in the first message onto the authentication table TB1.

In the second exemplary embodiment, the terminal apparatus 10B may include in the fourth message the hash value generated from the combination of the stored user name and password, and then transmit the fourth message. The authentication apparatus 30A may store the hash value included in the fourth message onto the authentication table TB1A.

In the exemplary embodiments, the number of hash values to be stored in a single record of the authentication table TB1 (the authentication table TB1A) is not limited to one. Multiple hash values corresponding to multiple users may be stored in a single record.

Programs of the apparatuses may be provided in a recorded form on a computer readable recording medium, and installed on the apparatuses. Such a computer readable recording media may include a magnetic recording medium (such as a magnetic tape, a magnetic disk (hard disk drive (HDD), or a flexible disk (FD)), an optical recording medium, a magneto-optical recording medium, or a semiconductor memory. The programs may also be downloaded via a communication network, and installed on the apparatuses.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication system comprising:
an authentication apparatus;
a router; and
a second apparatus,
wherein the authentication apparatus includes
a first acquisition unit that acquires first authentication information of a user of a first apparatus,
an authentication unit that performs authentication using the first authentication information acquired by the first acquisition unit, and
a first transmission unit that, in response to authentication results of the authentication unit, transmits an address of a second apparatus to the first apparatus and transmits an address of the router, which is connected to the first apparatus, to the second apparatus,
wherein the router includes a second transmission unit that acquires the address of the second apparatus and second authentication information of the user from the first apparatus, which is connected to the router, and transmits the address of the router together with the second authentication information to the second apparatus of the acquired address, and
wherein the second apparatus includes
a second acquisition unit that acquires the address transmitted by the first transmission unit,
a third acquisition unit that acquires the second authentication information and the address transmitted by the second transmission unit, and
a connection unit that establishes connection to the router if the address acquired by the second acquisition unit matches the address acquired by the third acquisition unit, and the second authentication information acquired by the third acquisition unit is stored on a memory.

2. The communication system according to claim 1, wherein the connection unit establishes no connection to the first apparatus if the third acquisition unit acquires the second authentication information and the address after a time elapse of a predetermined period of time from the acquisition of the address by the second acquisition unit.

3. The communication system according to claim 1,
wherein the authentication apparatus includes a generator that generates a one-time password,
wherein the first transmission unit transmits the one-time password to the first apparatus and the second apparatus,
wherein the router acquires as the second authentication information the one-time password transmitted by the first transmission unit and acquired by the first apparatus,
wherein the second acquisition unit acquires the one-time password transmitted by the first transmission unit, and
wherein the second apparatus includes a storage unit that stores on a memory the one-time password acquired by the second acquisition unit as the second authentication information.

4. The communication system according to claim 2,
wherein the authentication apparatus includes a generator that generates a one-time password,
wherein the first transmission unit transmits the one-time password to the first apparatus and the second apparatus,
wherein the router acquires as the second authentication information the one-time password transmitted by the first transmission unit and acquired by the first apparatus,
wherein the second acquisition unit acquires the one-time password transmitted by the first transmission unit, and
wherein the second apparatus includes a storage unit that stores on a memory the one-time password acquired by the second acquisition unit as the second authentication information.

5. A communication system comprising:
an authentication apparatus;
a first router;
a second apparatus; and
a second router,
wherein the authentication apparatus includes
a first acquisition unit that acquires first authentication information of a user of a first apparatus,
an authentication unit that performs authentication using the first authentication information acquired by the first acquisition unit, and
a first transmission unit that, in response to authentication results of the authentication unit, transmits an address of the second router connected to a second apparatus to the first apparatus and transmits an address of the first router, which is connected to the first apparatus, to the second apparatus,
wherein the first router includes a second transmission unit that acquires from the first apparatus, which is connected to the first router, the address of the second router and second authentication information of the user, and transmits the address of the first router together with the second authentication information to the second router of the acquired address,
wherein the second apparatus includes
a second acquisition unit that acquires the address of the first router transmitted by the first transmission unit, and
a third transmission unit that transmits to the second router, which is connected to the second apparatus, the address of the first router acquired by the second acquisition unit and the second authentication information of the user, and
wherein the second router includes
a third acquisition unit that acquires the address of the first router and the second authentication information transmitted by the third transmission unit,
a storage unit that stores on a memory the address of the first router and the second authentication information acquired by the third acquisition unit,
a fourth acquisition unit that acquires the address and the second authentication information transmitted by the second transmission unit, and
a connection unit that establishes connection to the first router if the address and the second authentication information acquired by the fourth acquisition unit are stored on the memory.

6. The communication system according to claim 5, wherein the connection unit establishes no connection to the first router if the fourth acquisition unit acquires the second authentication information and the address after a time elapse of a predetermined period of time from the acquisition of the address by the third acquisition unit.

7. The communication system according to claim 5,
wherein the authentication apparatus comprises a generator that generates a one-time password,
wherein the first transmission unit transmits the one-time password to the first apparatus and the second apparatus,
wherein the first router acquires as the second authentication information the one-time password transmitted by the first transmission unit and acquired by the first apparatus,
wherein the second acquisition unit acquires the one-time password transmitted by the first transmission unit, and
wherein the third transmission unit transmits the one-time password acquired by the second acquisition unit as the second authentication information.

8. The communication system according to claim 6,
wherein the authentication apparatus comprises a generator that generates a one-time password,
wherein the first transmission unit transmits the one-time password to the first apparatus and the second apparatus,
wherein the first router acquires as the second authentication information the one-time password transmitted by the first transmission unit and acquired by the first apparatus,
wherein the second acquisition unit acquires the one-time password transmitted by the first transmission unit, and
wherein the third transmission unit transmits the one-time password acquired by the second acquisition unit as the second authentication information.

9. A router comprising:
a storage unit that acquires from an apparatus connected to the router an address of the router configured to be connected to the router and authentication information of a user of the apparatus connected to the router, and stores the acquired address and authentication information on a memory;
an acquisition unit that acquires from the router requesting connection to the router the address of the router, and the authentication information of the user of the apparatus connected to the router; and
a connection unit that establishes connection to the router requesting the connection to the router if the address and the authentication information acquired by the acquisition unit are stored on the memory.
